(19) United States
(12) Patent Application Publication
(10) Pub. No.: US 2024/0346203 A1
(43) Pub. Date: Oct. 17, 2024

(54) METHOD AND SYSTEM FOR SYNTHETIC EVENT SERIES GENERATION

(71) Applicant: JPMorgan Chase Bank, N.A., New York, NY (US)

(72) Inventors: Renbo ZHAO, Cambridge, MA (US); Niccolo DALMASSO, Long Island City, NY (US); Mohsen GHASSEMI, Jersey City, NJ (US); Vamsi Krishna POTLURU, New York, NY (US); Tucker Richard BALCH, Suwanee, GA (US); Manuela VELOSO, New York, NY (US)

(73) Assignee: JPMorgan Chase Bank, N.A., New York, NY (US)

(21) Appl. No.: 18/134,188

(22) Filed: Apr. 13, 2023

(51) Int. Cl. G06F 30/20

(52) U.S. Cl. CPC G06F 30/20; G06Q 40/02

(57) ABSTRACT

A method for using multidimensional Hawkes processes for modeling and generating sequential events data in order to improve accuracy with respect to parameter estimation for various domains such as finance, epidemiology, and personalized recommendations is provided. The method includes: receiving information that relates to a sequence of events; modeling, based on the received information, the sequence of events by a multidimensional Hawkes process that relates to a conditional density function that includes a base intensity component and a cross-activation matrix component; defining, based on the conditional density function, a log-likelihood function that is dimensionally separable; and determining a maximum-likelihood estimation of a solution to the log-likelihood function along at least one dimension. The maximum-likelihood estimation may be determined by adapting a Frank-Wolfe algorithm by adding an away-step computation thereto and using the adapted Frank-Wolfe algorithm for determining the maximum-likelihood estimation of the solution to the log-likelihood function.

### BACKGROUND

### 1. Field of the Disclosure

This technology generally relates to methods and systems for modeling and generating sequential events data, and more particularly to methods and systems for using multidimensional Hawkes processes for modeling and generating sequential events data in order to improve accuracy with respect to parameter estimation for various domains such as finance, epidemiology, and personalized recommendations.

### 2. Background Information

Sequential events data is ubiquitous in many domains of application. In banking, “customer journeys” log the interactions of a customer with the bank. In finance, limit order books record buy or sell orders on a security at a specific price or better. In epidemiology, infection data are used to understand the spread pattern of different infectious diseases. Click-stream data in advertising, earthquake magnitude logs for a specific region in seismology, social media posting and interactions, and occurrences of crime in a neighborhood are among other examples of event series data. A sequence in event series data is composed of multiple events, potentially of different types. Unlike time series data, these events may occur at irregular times, that is, the time interval between two events is not predetermined; and event sequences in a sequential event data set need not to be synchronous. Moreover, the probability of occurrence of an event at time t may depend on the history of the events in that sequence up to time t. Therefore, some of the interesting problems that arise when dealing with sequential events data include predicting the time and the type of the next event, causal inference among the events, and intervention to influence the occurrence of future events.

A powerful tool to model the occurrence of events in sequential events data is temporal point processes. They model the probability of occurrence of an event of a given type at any time t, possibly as a function of the history up to time t. Notably, Hawkes processes (i.e., self-exciting point processes) are a common class of temporal point processes that model sequential event series in which an occurrence of an event may increase the probability of occurrence of the future events. Temporal point processes are particularly useful, as they can also be employed as generative models. Once the temporal process parameters are learned, one can generate synthetic sequential events data with the same temporal dynamics.

Accordingly, there is a need for a mechanism for using multidimensional Hawkes processes for modeling and generating sequential events data in order to improve accuracy with respect to parameter estimation for various domains such as finance, epidemiology, and personalized recommendations.

### SUMMARY

The present disclosure, through one or more of its various aspects, embodiments, and/or specific features or sub-components, provides, inter alia, various systems, servers, devices, methods, media, programs, and platforms for methods and systems for using multidimensional Hawkes processes for modeling and generating sequential events data in order to improve accuracy with respect to parameter estimation for various domains such as finance, epidemiology, and personalized recommendations.

According to an aspect of the present disclosure, a method for generating sequential events data is provided. The method is implemented by at least one processor. The method includes: receiving, by the at least one processor, first information that relates to a sequence of events; modeling, by the at least one processor based on the received first information, the sequence of events by a multidimensional Hawkes process that relates to a conditional density function that includes a base intensity component and a cross-activation matrix component; defining, by the at least one processor based on the conditional density function, a log-likelihood function that is dimensionally separable; and applying, by the at least one processor, a Frank-Wolfe algorithm for determining a maximum-likelihood estimation of a solution to the log-likelihood function along at least one dimension.

The determining may include adapting the Frank-Wolfe algorithm by adding one from among a toward-step computation and an away-step computation and applying the adapted Frank-Wolfe algorithm for determining the maximum-likelihood estimation of the solution to the log-likelihood function.

The away-step computation may include computing a step size by using an exact line search technique.

Alternatively, the away-step computation may include computing a step size by using an adaptive step size technique.

The method may further include using a result of the applying of the adapted Frank-Wolfe algorithm to identify a sparsity pattern of the cross-activation matrix component.

The method may further include using the identified sparsity pattern to increase a convergence rate with respect to the determining of the maximum-likelihood estimation of the solution to the log-likelihood function along the at least one dimension.

A number of event types included in the sequence of events may be equal to a number of dimensions of the multivariate Hawkes process.

The sequence of events may be an asynchronous sequence of events for which a time interval between consecutive events is variable.

The sequence of events may include at least one from among a sequence of banking events that relates to customer interactions with a financial institution, a sequence of finance events that relates to buy orders and sell orders for a particular security, a sequence of epidemiological events that relates to a spread pattern of a particular infectious disease, a sequence of advertising events that relates to click-stream data, a sequence of seismological events that relates to earthquake magnitude logs for a particular geographical region, a sequence of social media events that relates to postings for a particular social media platform, and a sequence of crime events that relates to occurrences of criminal activity in a particular neighborhood.

According to another exemplary embodiment, a computing apparatus for generating sequential events data is provided. The computing apparatus includes a processor; a memory; and a communication interface coupled to each of the processor and the memory. The processor is configured to: receive, via the communication interface, first information that relates to a sequence of events; model, based on the received first information, the sequence of events by a multidimensional Hawkes process that relates to a conditional density function that includes a base intensity component and a cross-activation matrix component; define, based on the conditional density function, a log-likelihood function that is dimensionally separable; and apply a Frank-Wolfe algorithm for determining a maximum-likelihood estimation of a solution to the log-likelihood function along at least one dimension.

The processor may be further configured to adapt the Frank-Wolfe algorithm by adding one from among a toward-step computation and an away-step computation, and to apply the adapted Frank-Wolfe algorithm for determining the maximum-likelihood estimation of the solution to the log-likelihood function.

The away-step computation may include a computation of a step size that is performed by using an exact line search technique.

Alternatively, the away-step computation may include a computation of a step size that is performed by using an adaptive step size technique.

The processor may be further configured to use a result of the application of the adapted Frank-Wolfe algorithm to identify a sparsity pattern of the cross-activation matrix component.

The processor may be further configured to use the identified sparsity pattern to increase a convergence rate with respect to the determination of the maximum-likelihood estimation of the solution to the log-likelihood function along the at least one dimension.

A number of event types included in the sequence of events may be equal to a number of dimensions of the multivariate Hawkes process.

The sequence of events may be an asynchronous sequence of events for which a time interval between consecutive events is variable.

The sequence of events may include at least one from among a sequence of banking events that relates to customer interactions with a financial institution, a sequence of finance events that relates to buy orders and sell orders for a particular security, a sequence of epidemiological events that relates to a spread pattern of a particular infectious disease, a sequence of advertising events that relates to click-stream data, a sequence of seismological events that relates to earthquake magnitude logs for a particular geographical region, a sequence of social media events that relates to postings for a particular social media platform, and a sequence of crime events that relates to occurrences of criminal activity in a particular neighborhood.

According to yet another exemplary embodiment, a non-transitory computer readable storage medium storing instructions for generating sequential events data is provided. The storage medium includes executable code which, when executed by a processor, causes the processor to: receive first information that relates to a sequence of events; model, based on the received first information, the sequence of events by a multidimensional Hawkes process that relates to a conditional density function that includes a base intensity component and a cross-activation matrix component; define, based on the conditional density function, a log-likelihood function that is dimensionally separable; and apply a Frank-Wolfe algorithm for determining a maximum-likelihood estimation of a solution to the log-likelihood function along at least one dimension.

When executed by the processor, the executable code may further cause the processor to adapt the Frank-Wolfe algorithm by adding one from among a toward-step computation and an away-step computation, and to apply the adapted Frank-Wolfe algorithm for determining the maximum-likelihood estimation of the solution to the log-likelihood function.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for using multidimensional Hawkes processes for modeling and generating sequential events data in order to improve accuracy with respect to parameter estimation for various domains such as finance, epidemiology, and personalized recommendations.

FIG. 4 is a flowchart of an exemplary process for implementing a method for using multidimensional Hawkes processes for modeling and generating sequential events data in order to improve accuracy with respect to parameter estimation for various domains such as finance, epidemiology, and personalized recommendations.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

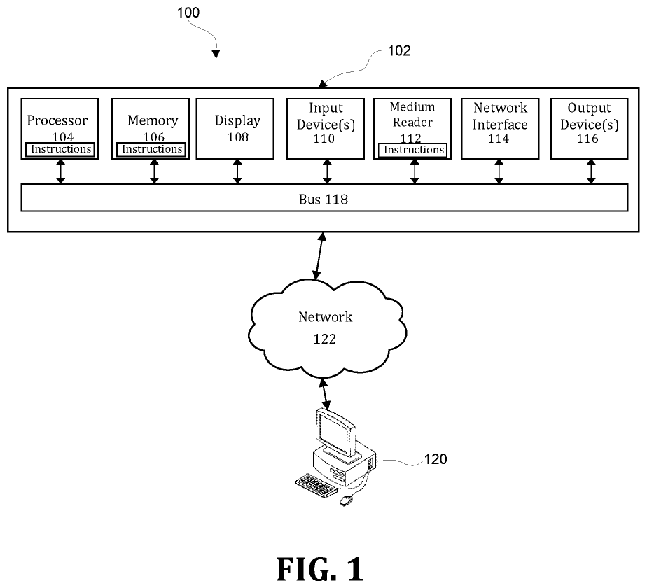

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for using multidimensional Hawkes processes for modeling and generating sequential events data in order to improve accuracy with respect to parameter estimation for various domains such as finance, epidemiology, and personalized recommendations.

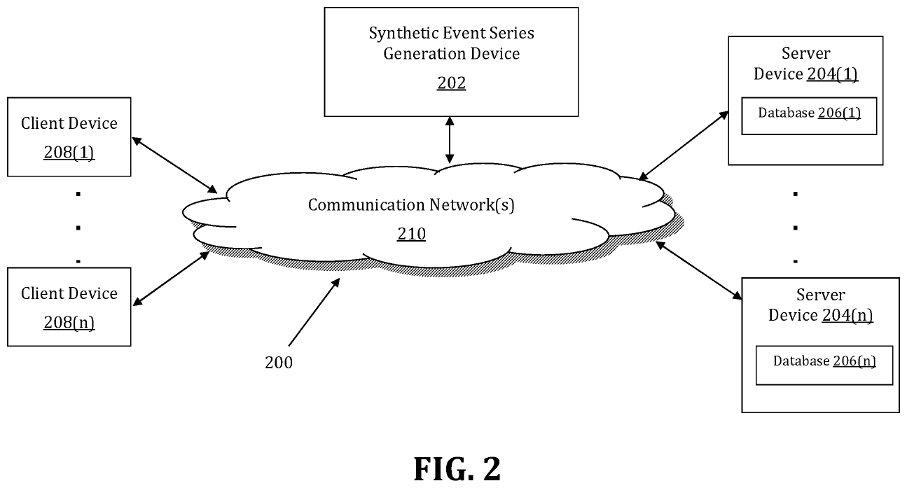

Referring to FIG. 2, a schematic of an exemplary network environment 200 for implementing a method for using multidimensional Hawkes processes for modeling and generating sequential events data in order to improve accuracy with respect to parameter estimation for various domains such as finance, epidemiology, and personalized recommendations is illustrated. In an exemplary embodiment, the method is executable on any networked computer platform, such as, for example, a personal computer (PC).

The method for using multidimensional Hawkes processes for modeling and generating sequential events data in order to improve accuracy with respect to parameter estimation for various domains such as finance, epidemiology, and personalized recommendations may be implemented by a Synthetic Event Series Generation (SESG) device 202. The SESG device 202 may be the same or similar to the computer system 102 as described with respect to FIG. 1. The SESG device 202 may store one or more applications that can include executable instructions that, when executed by the SESG device 202, cause the SESG device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the SESG device 202 itself, may be located in virtual server(s) running in a cloud-based computing environment rather than being tied to one or more specific physical network computing devices. Also, the application(s) may be running in one or more virtual machines (VMs) executing on the SESG device 202. Additionally, in one or more embodiments of this technology, virtual machine(s) running on the SESG device 202 may be managed or supervised by a hypervisor.

In the network environment 200 of FIG. 2, the SESG device 202 is coupled to a plurality of server devices 204(1)-204(n) that hosts a plurality of databases 206(1)-206(n), and also to a plurality of client devices 208(1)-208(n) via communication network(s) 210. A communication interface of the SESG device 202, such as the network interface 114 of the computer system 102 of FIG. 1, operatively couples and communicates between the SESG device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SESG device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and SESG devices that efficiently implement a method for using multidimensional Hawkes processes for modeling and generating sequential events data in order to improve accuracy with respect to parameter estimation for various domains such as finance, epidemiology, and personalized recommendations.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The SESG device 202 may be a standalone device or integrated with one or more other devices or apparatuses, such as one or more of the server devices 204(1)-204(n), for example. In one particular example, the SESG device 202 may include or be hosted by one of the server devices 204(1)-204(n), and other arrangements are also possible. Moreover, one or more of the devices of the SESG device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the SESG device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to historical Hawkes process time-sequential events and data that relates to intensity and excitation function parameters of Hawkes processes.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the SESG device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the SESG device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the SESG device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the SESG device 202, the server devices 204(1)-204(n), or the client devices 208(1)-208(n), for example, may be configured to operate as virtual instances on the same physical machine. In other words, one or more of the SESG device 202, the server devices 204(1)-204(n), or the client devices 208(1)-208(n) may operate on the same physical device rather than as separate devices communicating through communication network(s) 210. Additionally, there may be more or fewer SESG devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

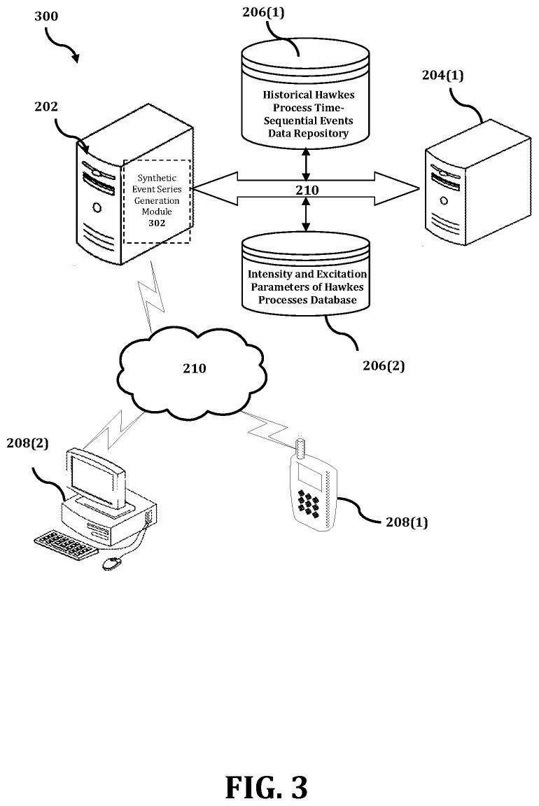

The SESG device 202 is described and illustrated in FIG. 3 as including a synthetic event series generation module 302, although it may include other rules, policies, modules, databases, or applications, for example. As will be described below, the synthetic event series generation module 302 is configured to implement a method for using multidimensional Hawkes processes for modeling and generating sequential events data in order to improve accuracy with respect to parameter estimation for various domains such as finance, epidemiology, and personalized recommendations.

An exemplary process 300 for implementing a mechanism for using multidimensional Hawkes processes for modeling and generating sequential events data in order to improve accuracy with respect to parameter estimation for various domains such as finance, epidemiology, and personalized recommendations by utilizing the network environment of FIG. 2 is illustrated as being executed in FIG. 3. Specifically, a first client device 208(1) and a second client device 208(2) are illustrated as being in communication with SESG device 202. In this regard, the first client device 208(1) and the second client device 208(2) may be “clients” of the SESG device 202 and are described herein as such. Nevertheless, it is to be known and understood that the first client device 208(1) and/or the second client device 208(2) need not necessarily be “clients” of the SESG device 202, or any entity described in association therewith herein. Any additional or alternative relationship may exist between either or both of the first client device 208(1) and the second client device 208(2) and the SESG device 202, or no relationship may exist.

Further, SESG device 202 is illustrated as being able to access a historical Hawkes process time-sequential events data repository 206(1) and an intensity and excitation parameters of Hawkes processes database 206(2). The synthetic event series generation module 302 may be configured to access these databases for implementing a method for using multidimensional Hawkes processes for modeling and generating sequential events data in order to improve accuracy with respect to parameter estimation for various domains such as finance, epidemiology, and personalized recommendations.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the SESG device 202 via broadband or cellular communication. Of course, these embodiments are merely exemplary and are not limiting or exhaustive.

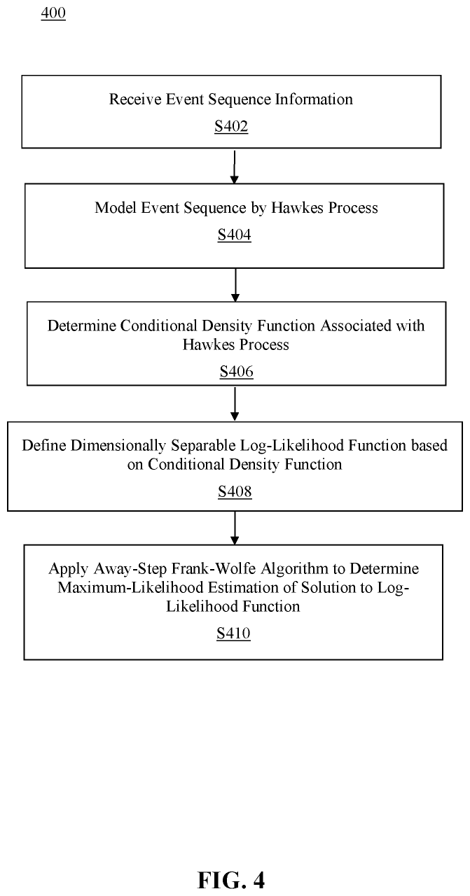

Upon being started, the synthetic event series generation module 302 executes a process for using multidimensional Hawkes processes for modeling and generating sequential events data in order to improve accuracy with respect to parameter estimation for various domains such as finance, epidemiology, and personalized recommendations. An exemplary process for using multidimensional Hawkes processes for modeling and generating sequential events data in order to improve accuracy with respect to parameter estimation for various domains such as finance, epidemiology, and personalized recommendations is generally indicated at flowchart 400 in FIG. 4.

In process 400 of FIG. 4, at step S402, the synthetic event series generation module 302 receives a first set of information that relates to a sequence of events. In an exemplary embodiment, the sequence of events is an asynchronous sequence, in that the time between consecutive events is not regular, and may be random. In an exemplary embodiment, the first set of information includes second information that indicates a time of occurrence for each respective event and third information that indicates an identity of at least one individual person associated with the respective event.

At step S404, the synthetic event series generation module 302 models the sequence of events by a multidimensional Hawkes process. Then, at step S406, the synthetic event series generation module 306 determines a conditional density function that is associated with the multidimensional Hawkes process. In an exemplary embodiment, the conditional density function includes a base intensity component and a cross-activation matrix component.

At step S408, the synthetic event series generation module 302 uses the conditional density function that is associated with the multidimensional Hawkes process to define a log-likelihood function that is dimensionally separable. Then, at step S410, the synthetic event series generation module 302 determines a maximum-likelihood estimation of a solution to the log-likelihood function along at least one dimension by applying a Frank-Wolfe algorithm. The synthetic event series generation module then uses a result of this estimation operation to generate a synthetic event series.

In an exemplary embodiment, the Frank-Wolfe algorithm may be adapted by adding an away-step computation. Then, at step S410, the synthetic event series generation module 302 applies the adapted Frank-Wolfe algorithm to the log-likelihood function in order to determine the maximum-likelihood estimation thereof.

In an exemplary embodiment, there is a focus on efficiently learning multidimensional Hawkes processes, as accurate, fast and scalable optimization algorithms to enable a more widespread use of synthetic sequential events data that reflect dynamics observed in the real data. While in recent years a lot of focus has been devoted to Hawkes process variants that can capture more complex influence patterns among events, efficient and scalable learning of Hawkes processes parameters have remained relatively under-examined. In particular, when a large number of event types is present in the data, algorithms which are naturally able to provide sparse solutions in a fast runtime are needed. In this aspect, a sparse solution may be understood as one that identifies that some event types may only influence the occurrence of a relatively small subset of other events types in the future. Current state-of-the-art approaches achieve that, but either provide no guarantees that solutions found belong to the feasible set or assume upper bounds on dual variables are known and available a priori.

In an exemplary embodiment, a first order optimization algorithm called “Away-Step Frank-Wolfe” is used for learning multidimensional Hawkes processes. In this regard, it may be shown that the [symbol] ₁-regularized maximum likelihood estimation objective can be reformulated as a logarithmic barrier problem over a simplex, which is a natural fit for Frank-Wolfe optimization algorithms. Experiments show that the Away-Step Frank-Wolfe algorithm is quite computationally efficient in solving the [symbol] ₁-regularized sparse Hawkes process inference problem.

Inference of Multidimensional Hawkes Processes: The following provides background on maximum likelihood inference of multidimensional Hawkes processes and details on how to reformulate the optimization problem to be solved efficiently via first order methods.

Maximum-Likelihood Estimation (MLE): An m-dimensional multivariate Hawkes process can be described as follows. Fix a time interval T:=[0,t), and let [symbol] :={(tᵢ,hᵢ)}ᵢ₌₁ⁿ be the arrival points in this interval, where for each i∈[n], tᵢ denotes the arrival time and hᵢ∈[m] denotes the index of the dimension along which the point arrives. For each dimension k∈[m], the conditional density function is given by Equation 1 below:

$${λ}_{k} ( t ) := {μ}_{k} + {P}_{i : ti < t} {a}_{hi , k} ζ ( t - {t}_{i} ) , \qquad ( 1 )$$

$$∀ t > 0 ,$$

where μₖ≥0 is the base intensity, aₕ_{ᵢ}_{,k}≥0 is the mutual-excitation coefficient from dimension hᵢ to dimension k, and ξ:R₊→R₊ is the kernel function. Define the base intensity vector μ:=(μₖ)_{k∈[m]} and the cross-activation matrix A:=(a_{k,l})_{k,l∈[m]}. Given the arrival points D in T, the log-likelihood function can be written as Equation 2 below:

$$( 2 )$$

$$L ( μ , A ) := {\sum }_{i = 1}^{n} ln {λ}_{{h}_{i}} ( {t}_{i} ) - {\sum }_{k = 1}^{m} {\int }_{0}^{t} {λ}_{k} ( s ) ds = {\sum }_{i = 1}^{n} ln ( {μ}_{{h}_{i}} + \text{?} {a}_{{h}_{j} , {h}_{i}} ζ ( - ( {t}_{i} - {t}_{j} ) ) ) - {\sum }_{k = 1}^{m} ( {μ}_{k} t + {\sum }_{i = 1}^{n} {a}_{{h}_{i} , k} {\int }_{0}^{t} ζ ( - ( s - {t}_{i} ) ) ds ) .$$

$$\text{?} \text{indicates text missing or illegible when filed}$$

The following definition is provided: Hₖ(t):={i∈[n]:tᵢ<t, hᵢ=k} for k∈[m], so that {Hₖ(t)}_{k∈[m]} forms a partition of [n]. It is assumed that Hₖ(t)≠Ø for all k∈[m]. This happens with high probability if tis large enough. It may then be observed that the log-likelihood function L(·,·) is separable across the m dimensions, namely

$$L ( μ , A ) := {\sum }_{k = 1}^{m} {L}_{k} ( {μ}_{k} , {a}_{k} ) ,$$

where a^{T}ₖ denotes the k-th row of A, and then Equation 3 below holds:

$${L}_{k} ( {μ}_{k} , {a}_{k} ) = \text{?} ln ( {μ}_{k} + {\sum }_{l - 1}^{m} {a}_{l , k} {\sum }_{j ∈ {ℋ}_{l} ( {t}_{i} )} ζ ( - ( {t}_{i} - {t}_{j} ) ) ) - ( {μ}_{k} t + {\sum }_{l - 1}^{m} {a}_{l , k} {\sum }_{i ∈ {ℋ}_{l} ( t )} \text{?} ζ ( - ( s - {t}_{i} ) ) ds ) . \qquad ( 3 )$$

$$\text{?} \text{indicates text missing or illegible when filed}$$

In particular, if ζ(t)=exp(−t) for t>0 and 0 for t≤0, then Equation 4 below holds:

$${L}_{k} ( {μ}_{k} , {a}_{k} ) = \text{?} ln ( {μ}_{k} + {\sum }_{l - 1}^{m} {a}_{l , k} {\sum }_{j ∈ {ℋ}_{l} ( {t}_{i} )} exp ( - ( {t}_{i} - {t}_{j} ) ) ) - ( {μ}_{k} t + {\sum }_{l - 1}^{m} {a}_{l , k} \text{?} ( 1 - exp ( - ( t - {t}_{i} ) ) ) ) = \text{?} ln ( {μ}_{k} + {\sum }_{l = 1}^{m} \text{?} {\overline{w}}_{i , l} ) - ( {μ}_{k} t + {\sum }_{l = 1}^{m} {a}_{l , k} \text{?} ) \qquad ( 4 )$$

$$\text{?} \text{indicates text missing or illegible when filed}$$

where for all i∈Hₖ(t) and I∈[m],

$${\overline{w}}_{i , l} := {\sum }_{j ∈ {H}_{l} ( {t}_{i} )} exp ( - ( {t}_{i} - {t}_{j} ) ) \geq 0$$

$$and$$

$${v}_{l} := {\sum }_{i ∈ {H}_{l} ( t )} [ 1 - exp ( - ( t - {t}_{i} ) ) ]$$

It is noted that since Hₗ(t)≠Ø, it is also true that v̅ₗ>0, for all l∈[m]. Therefore, the maximum-likelihood estimation along the k-th dimension is equal to the expression shown in Expression 6 below:

$$\text{?} - {\sum }_{i ∈ {ℋ}_{k} ( t )} ln ( {μ}_{k} + {\overline{w}}_{i}^{T} {a}_{k} ) + ( {μ}_{k} t + {\overline{υ}}^{T} {a}_{k} ) . \qquad ( 6 )$$

$$\text{?} \text{indicates text missing or illegible when filed}$$

Sometimes, to promote the sparsity of the coefficients {a_{l,k}}ₗ₌₁^{m}, a [symbol] ₁-regularizer may be added Expression (6), thereby resulting in Expression (7) below:

$$\text{?} - {\sum }_{i ∈ {ℋ}_{k} ( t )} ln ( {μ}_{k} + {\overline{w}}_{i}^{T} {a}_{k} ) + ( {μ}_{k} t + {\overline{υ}}^{T} {a}_{k} ) + λ {‖ {a}_{k} ‖}_{1} . \qquad ( 7 )$$

$$\text{?} \text{indicates text missing or illegible when filed}$$

Note that since aₖ≥0, ∥aₖ∥₁ may be replaced with the linear function e^{⊥}aₖ where e:=(1, . . . , 1). The formulation in Expression (7) can also be interpreted as a maximum a-posteriori estimation of aₖ with independent exponential prior on the elements {a_{l,k}}ₗ₌₁^{m}.

Reformulation: It is noted that the optimization problems in Expression (6) and Expression (7) both fall under the following optimization model of Expression (8) below:

$${\overline{f}}^{*} := {min}_{z \geq 0 , z ∈ {ℝ}^{q}} [ \overline{f} ( z ) := - {\sum }_{i = 1}^{p} ln ( {w}_{i}^{T} z ) + {υ}^{T} z ] \qquad ( 8 )$$

For example, in Expression (7), it is true that p=|Hₖ(t)|, and Equation (9) below holds:

$$z = [ \begin{matrix}{μ}_{k} \\ {a}_{k}\end{matrix} ] , \qquad ( 9 )$$

$${w}_{i} = [ \begin{matrix}1 \\ {\overline{w}}_{i}\end{matrix} ] ,$$

$$υ = [ \begin{matrix}t \\ \overline{υ} + λ e\end{matrix} ]$$

Since v>0, it is permissible to set y=v·z, where · denotes element-wise product, and rewrite Expression (8) as shown in Expression (10) below:

$${min}_{y \geq 0} - {\sum }_{i = 1}^{p} ln ( {\tilde{w}}_{i}^{T} y ) + {e}^{T} y , \qquad ( 10 )$$

where \tilde{w}ᵢ=w/υ. Henceforth, for two vectors x, y∈R^{q}, x/y is interpreted element-wise. Using standard techniques, namely by writing y=tx for t≥0 and x∈Δ_{q}:={x∈R^{q}:x≥0, e^{T}x=1} and minimizing over t≥0, Expression (10) may be rewritten as shown in Expression (11) below:

$${f}^{*} := {min}_{x ∈ {Δ}_{q}} [ f ( x ) := - {\sum }_{i = 1}^{p} ln ( {\tilde{w}}_{i}^{T} x ) ] \qquad ( 11 )$$

It is known that x* is an optimal solution of Expression (11) if and only if z*=px*/v is an optimal solution of Expression (8). It is noted that the objective functions in Expression (8) and Expression (11) have are similar, namely they are both convex but are neither Lipschitz nor have Lipschitz gradient on the feasible set. This fact poses great challenges to the classical first-order methods. However, compared to the problem in Expression (8), the problem in Expression (11) has a form that is more amenable to some first-order methods. As a result, Expression (11) may be solved as a way of solving Expression (8).

First order methods/algorithms for solving Expression (11): As described above, reformulating the minimization of the log-likelihood as the minimization in Expression (11) allows for the use of a series of first-order methods. In particular, the following first-order methods are considered: 1) Multiplicative gradient (MG) method; 2) Relatively-smooth gradient method (RSGM); 3) Frank-Wolfe method for log-homogeneous self-concordant barriers (FW-LHB); and 4) Hawkes ADM4 algorithm for sparse Hawkes processes estimation.

In an exemplary embodiment, for RSGM, RSGM with fixed stepsize (RSGM-F) is used, and its variant where the step-size is chosen via backtracking line-search (RSGM-LS) may also be used.

In an exemplary embodiment, for FW-LHB, FW-LHB with adaptive stepsize (FW-LHB-A) is used, and FW-LHB with step-size chosen via exact linesearch (FW-LHB-E) may also be used.

In an exemplary embodiment, when the Hawkes ADM4 algorithm is selected, the Hawkes ADM4 algorithm for sparse Hawkes processes estimation from the Python library tick, which is based on the alternating direction method of multipliers (ADMM) algorithm, is used. In particular, the setup with an l₁ penalty on the infectivity matrix is employed, in order to promote sparsity of the solution.

In addition to those, in an exemplary embodiment, adaptation of the Frank-Wolfe algorithm is provided in order to solve Expression (11). The “away-step” addition to the Frank-Wolfe algorithm allows for setting one of the solution dimensions to zero during each iteration. More specifically, the adaptation is referred to herein as the Away-Step Frank-Wolfe method for log-homogeneous self-concordant barriers (AFW-LHB) with adaptive step-size (AFW-LHB-A) and step-size chosen via exact line-search (AFW-LHB-E). The resulting adaptation is shown in Algorithm 1 below.

The crucial part of Algorithm 1 is that if the “away step” is chosen in Step 3 (b) and the step-size αₖ=−αₖ in Step 4, then aⱼ_{ₖ}^{k+1}=0. In other words, there is a natural landing on one of the vertices of the simplex, and naturally “sparse” iterations are produced. This is advantageous in two ways: (1) it allows to identify the sparsity pattern of the rows of the cross-activation matrix A; and (2) with the sparsity pattern identified correctly, the convergence rate also becomes faster.

### Algorithm 1: Away-Step Frank-Wolfe Method for Solving Expression (11):

Input: Starting point x⁰∈Δ_{q}. Denote the non-zero (positive) indices of x⁰ by I₀⊆[q]. At iteration k∈{0,1, . . . }:
1) Compute iₖ∈argmin_{i∈[q]}∇ᵢf(x^{k}) and Gₖ:= [symbol] ∇f(x^{k}),x^{k}−eᵢ_{ₖ} [symbol] , where eᵢ_{ₖ} denotes the iₖ-th standard coordinate vector.
2) Compute jₖ∈argmax_{i∈I}_{ₖ}∇ᵢf(x^{k}) and \tilde{G}ₖ:=<∇f(x^{k}),eⱼ_{ₖ}−x^{k}>.
3) Choose between the following two cases:
   a) “Toward step”: If | [symbol] ₖ|=1 or Gₖ>\tilde{G}ₖ, let d^{k}:=eᵢ_{ₖ}−x^{k} and a⁻ₖ:=1.
   b) “Away step”: Otherwise, let d^{k}:=x^{k}−eⱼ_{ₖ} and αₖ:=xⱼ_{ₖ}^{k}/(1−xⱼ_{ₖ}^{k}).
4) Choose αₖ∈(0, α⁻ₖ] in one of the following two ways:
   a) Exact line search: αₖ∈argmin_{α∈(0,α}_{^{−}}_{k]}F(x^{k}+αd^{k}).
   b) Adaptive stepsize: Compute Dₖ: [symbol] ∇²f(x^{k})d^{k},d^{k} [symbol] ^{1/2} and rₖ:=max {Gₖ,Gₑₖ}. If Dₖ=0, then αₖ:=⁻αₖ; otherwise, αₖ:=min{bₖ,α⁻ₖ}, where

$${b}_{k} := \frac{{r}_{k}}{{D}_{k} ( {r}_{k} + {D}_{k} )} .$$

5) Update x^{k+1}:=x^{k}+αₖd^{k} and the non-zero (positive) indices of x^{k+1} by Iₖ₊₁⊆[q].

Accordingly, with this technology, a process for using multidimensional Hawkes processes for modeling and generating sequential events data in order to improve accuracy with respect to parameter estimation for various domains such as finance, epidemiology, and personalized recommendations is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating sequential events data, the method being implemented by at least one processor, the method comprising:
receiving, by the at least one processor, first information that relates to a sequence of events;
modeling, by the at least one processor based on the received first information, the sequence of events by a multidimensional Hawkes process that relates to a conditional density function that includes a base intensity component and a cross-activation matrix component;
defining, by the at least one processor based on the conditional density function, a log-likelihood function that is dimensionally separable; and
applying, by the at least one processor, a Frank-Wolfe algorithm for determining a maximum-likelihood estimation of a solution to the log-likelihood function along at least one dimension.

2. The method of claim 1, wherein the determining comprises adapting the Frank-Wolfe algorithm by adding one from among a toward-step computation and an away-step computation and applying the adapted Frank-Wolfe algorithm for determining the maximum-likelihood estimation of the solution to the log-likelihood function.

3. The method of claim 2, wherein the away-step computation comprises computing a step size by using an exact line search technique.

4. The method of claim 2, wherein the away-step computation comprises computing a step size by using an adaptive step size technique.

5. The method of claim 2, further comprising using a result of the applying of the adapted Frank-Wolfe algorithm to identify a sparsity pattern of the cross-activation matrix component.

6. The method of claim 5, further comprising using the identified sparsity pattern to increase a convergence rate with respect to the determining of the maximum-likelihood estimation of the solution to the log-likelihood function along the at least one dimension.

7. The method of claim 1, wherein a number of event types included in the sequence of events is equal to a number of dimensions of the multivariate Hawkes process.

8. The method of claim 1, wherein the sequence of events is an asynchronous sequence of events for which a time interval between consecutive events is variable.

9. The method of claim 1, wherein the sequence of events comprises at least one from among a sequence of banking events that relates to customer interactions with a financial institution, a sequence of finance events that relates to buy orders and sell orders for a particular security, a sequence of epidemiological events that relates to a spread pattern of a particular infectious disease, a sequence of advertising events that relates to click-stream data, a sequence of seismological events that relates to earthquake magnitude logs for a particular geographical region, a sequence of social media events that relates to postings for a particular social media platform, and a sequence of crime events that relates to occurrences of criminal activity in a particular neighborhood.

10. A computing apparatus for generating sequential events data, the computing apparatus comprising:
a processor;
a memory; and
a communication interface coupled to each of the processor and the memory,
wherein the processor is configured to:
receive, via the communication interface, first information that relates to a sequence of events;
model, based on the received first information, the sequence of events by a multidimensional Hawkes process that relates to a conditional density function that includes a base intensity component and a cross-activation matrix component;
define, based on the conditional density function, a log-likelihood function that is dimensionally separable; and
apply a Frank-Wolfe algorithm for determining a maximum-likelihood estimation of a solution to the log-likelihood function along at least one dimension.

11. The computing apparatus of claim 10, wherein the processor is further configured to adapt the Frank-Wolfe algorithm by adding one from among a toward-step computation and an away-step computation, and to apply the adapted Frank-Wolfe algorithm for determining the maximum-likelihood estimation of the solution to the log-likelihood function.

12. The computing apparatus of claim 11, wherein the away-step computation comprises a computation of a step size that is performed by using an exact line search technique.

13. The computing apparatus of claim 11, wherein the away-step computation comprises a computation of a step size that is performed by using an adaptive step size technique.

14. The computing apparatus of claim 11, wherein the processor is further configured to use a result of the application of the adapted Frank-Wolfe algorithm to identify a sparsity pattern of the cross-activation matrix component.

15. The computing apparatus of claim 14, wherein the processor is further configured to use the identified sparsity pattern to increase a convergence rate with respect to the determination of the maximum-likelihood estimation of the solution to the log-likelihood function along the at least one dimension.

16. The computing apparatus of claim 10, wherein a number of event types included in the sequence of events is equal to a number of dimensions of the multivariate Hawkes process.

17. The computing apparatus of claim 10, wherein the sequence of events is an asynchronous sequence of events for which a time interval between consecutive events is variable.

18. The computing apparatus of claim 10, wherein the sequence of events comprises at least one from among a sequence of banking events that relates to customer interactions with a financial institution, a sequence of finance events that relates to buy orders and sell orders for a particular security, a sequence of epidemiological events that relates to a spread pattern of a particular infectious disease, a sequence of advertising events that relates to click-stream data, a sequence of seismological events that relates to earthquake magnitude logs for a particular geographical region, a sequence of social media events that relates to postings for a particular social media platform, and a sequence of crime events that relates to occurrences of criminal activity in a particular neighborhood.

19. A non-transitory computer readable storage medium storing instructions for generating sequential events data, the storage medium comprising executable code which, when executed by a processor, causes the processor to:
receive first information that relates to a sequence of events;
model, based on the received first information, the sequence of events by a multidimensional Hawkes process that relates to a conditional density function that includes a base intensity component and a cross-activation matrix component;
define, based on the conditional density function, a log-likelihood function that is dimensionally separable; and
apply a Frank-Wolfe algorithm for determining a maximum-likelihood estimation of a solution to the log-likelihood function along at least one dimension.

20. The storage medium of claim 19, wherein when executed by the processor, the executable code further causes the processor to adapt the Frank-Wolfe algorithm by adding one from among a toward-step computation and an away-step computation, and to apply the adapted Frank-Wolfe algorithm for determining the maximum-likelihood estimation of the solution to the log-likelihood function.
